(19) United States
(12) Patent Application Publication
(10) Pub. No.: US 2008/0252451 A1
(43) Pub. Date: Oct. 16, 2008

(54) Monitoring Device for Windows and Doors

(75) Inventor: Thomas Buchhalter, Niederkassel (DE)

Correspondence Address: DARBY & DARBY P.C., P.O. BOX 770, Church Street Station, New York, NY, 10008-0770, US

(73) Assignee: WERU AG, Rudersberg (DE)

(21) Appl. No.: 11/817,198

(22) PCT Filed: Feb. 27, 2006
(86) PCT No.: PCT/EP06/01795

§ 371 Date: May 16, 2008

(30) Foreign Application Priority Data
Feb. 25, 2005 (EP) 05101470.2
Apr. 22, 2005 (DE) 202005006796.2

(51) Int. Cl. G08B 13/08; E05B 65/10

(52) U.S. Cl. 340/545.1; 49/141

(57) ABSTRACT

A monitoring device for securing windows and doors, the swivellable handle of which is held on a handle fitting and can be connected, rotation-resistant, via a multi-sided insert pin to locking devices, with a housing at least partly accommodating the monitoring device which is penetrated by the multi-sided guide-pin with a first sensor device to detect the swivel position of the handle and with a second sensor device to detect the closed position and with an evaluation unit which combines and evaluates the detection signals from the first and the second sensor devices and optionally prompts an alarm signal, wherein the first sensor device has two microswitches arranged along the periphery of the multi-sided insert pin at an angle to each other, which are arranged in the housing and which can be actuated by a switching cam connected rotation-resistant to the handle, and in that the second sensor device is formed by at least one sealed-contact switch which is arranged near an outer wall of the housing, and by a magnet, cooperating with the at least one sealed-contact switch, which is attached to the closure-side arm of the fixed frame of the window or door.

This is a U.S. National Phase application under 35 U.S.C. §371 of International Application No. PCT/EP2006/00175, filed Feb. 27, 2006 and claims the benefit of European Patent Application No. EP 05101470.2, filed on Feb. 25, 2005 and German Patent Application No. 20 2005 006796.2, filed on Apr. 22, 2005. The International Application was published in German on Aug. 31, 2006 as WO 2006/089795 under PCT Article 21 (2).

The present invention relates to a monitoring device for securing windows and doors.

### BACKGROUND

With such a monitoring device known from DE 296 03 917 U1 the first sensor device is formed by a magnet set into the multi-sided insert pin and a sealed-contact switch arranged around the multi-sided insert pin, which brings with it the disadvantage that the tilt position of a window or door cannot be distinguished from an unlocked open position. In addition this arrangement is costly and difficult to realize. The second sensor device is arranged on the handle fitting, which is also costly. The purpose of this second sensor device is to establish whether the door or window wing is open. With this monitoring device the signals delivered by the evaluation unit are sent via a transmitter to a central monitoring station, which does not provide an immediate deterrent effect vis-à-vis an unauthorized person.

### SUMMARY OF THE INVENTION

An object of the present invention is to create a monitoring device of the initially named type for securing windows and doors which is simpler in design and easier to install and which distinguishes between the, usually three, wing positions (open position, tilt position, locked closed position). According to embodiments an immediate alarm facility is to be provided at the place of installation and the possibility offered of design for windows and doors regardless of their stop side.

Through the measures according to the invention, firstly a simplification of the first sensor device is achieved in terms of design, structure and also installation. It is possible to distinguish the, usually three, handle positions and to identify these for example via indicator lamps. Furthermore the design and arrangement of the second sensor device is such that in every case an allocation of sealed-contact switch and magnet is secure and positioned such that there is an immediate possibility of expansion regardless of whether the window or door wing has a stop on the left or right.

Structural and installation advantages of the first sensor device result from a switching element having a switching cam that may be disposed between the multi-sided insert pin and the microswitch. The switching element may be held housed rotatably, in the housing. The switching cam is provided in axial or radial extension of the switching element. Wherein, depending on whether or which of the microswitches provided in the form of keys is actuated, the three handle positions can be distinguished.

According to a preferred embodiment of the present invention two sealed-contact switches are arranged spaced apart in each case along opposite side walls of the housing. This permits in a very simple and more cost-favourable manner a monitoring device which is immediately suitable for both the left stop and the right stop of a window or door wing. A double-wing arrangement of a window or door with a central fixed closure arm is also possible without further cost.

Advantageous designs with regard to the arrangement and attachment of the magnet allocated to the respective sealed-contact switch result from the features of one or more claims. There is a preferred embodiment example, in which the magnet is held in or against a support which is in the form of a closure piece provided in the fixed frame because, in this configuration of the magnet arrangement, the latter, as well as the closure fittings concerned, can be attached to or screwed robotically to the fixed frame.

According toone embodiment, a microprocessor is provided for rapid data evaluation and operation.

According to a further embodiment, a device generating a visual and/or acoustic alarm provides a direct deterrent starting from the window or door concerned and affecting the intruder.

In a further preferred embodiment, the handle fitting holding the handle is swivelable and integrated into the housing or essentials parts of the monitoring device. The housing may be disposed sunk in the closure-side from piece of the window or door wing. These may result in a further reduction in size, and thus an arrangement on the door which has little or no visual impact, is achieved.

The monitoring device may include a display devive to allow the user to be told whether the wing is locked to the fixed frame and thus whether a monitoring and alarm function is or is not operating.

Further versions of the monitoring device as regards housing and housing arrangement as well as the accommodation of various parts in the housing result from the features of further dependent claims.

The present invention further relates to a window or a door with a monitoring device.

In the case of a specific wing arrangement the common closure-side fixed frame piece may be provided with a common magnet for the second sensor device.

### BRIEF DESCRIPTION OF THE DRAWINGS

Further details of the invention are to be found in the following description in which the invention is described and illustrated in more detail with the help of the embodiment examples represented in the drawing. There are shown in:

FIG. 1 in partly broken-away and exploded schematic view, a monitoring device attached in each case on the closure-side to a window wing or its associated fixed frame according to a preferred embodiment example of the present invention,

FIGS. 2 and 2A a horizontal section through the window wing held closed against the fixed frame according to FIG. 1 and the part of the monitoring device held against the fixed frame, seen in oblique view,

FIG. 3 a top view of the part of the monitoring device arranged in the door wing, but according to a variant vis-à-vis FIG. 1,

FIG. 4 a section along the line IV-IV of FIG. 3,

FIG. 5 a section along the line V-V of FIG. 3,

FIG. 6 the part of the monitoring device according to FIG. 3, but represented schematically and in perspective from below, and

FIG. 7 a perspective representation of the part of the monitoring device, installable ready-assembled and on the closure side, into the window wing, but according to another embodiment example of the present invention.

### DETAILED DESCRIPTION

The monitoring device 10, 110 and 210 respectively represented in various embodiments or variants serves to detect the position of a door wing or of a window wing 11 vis-à-vis its fixed frame 12 and, when the wing 11 is in the locked closed position, act by means of an alarm device 13 operated by the monitoring device 10, 110, 210 as an alarm against unauthorized or forcible opening of the wing 11. The monitoring device 10, 110 and 210 respectively consists substantially of a main part 14, 114, 214 arranged and held in the wing 11 and an additional part 15 cooperating with and adjoining the latter in the fixed frame 12. Both the main part 14, 114, 214 and the additional part 15 are arranged in the respective closure-side frame piece 16 of the wing 11 or 17 of the fixed frame 12. The main part 14, 114, 214 of the monitoring device 10, 110, 210 is in active connection with a handle 20, 220 of the wing concerned 11 via its rotation-resistant multi-sided insert pin 19 which penetrates the main part 14, 114, 214 and is connected, in the closure-side frame piece 16 of the wing 11, to the closure mechanism, not shown, for locking, unlocking including opening, and tilting the window wing 11.

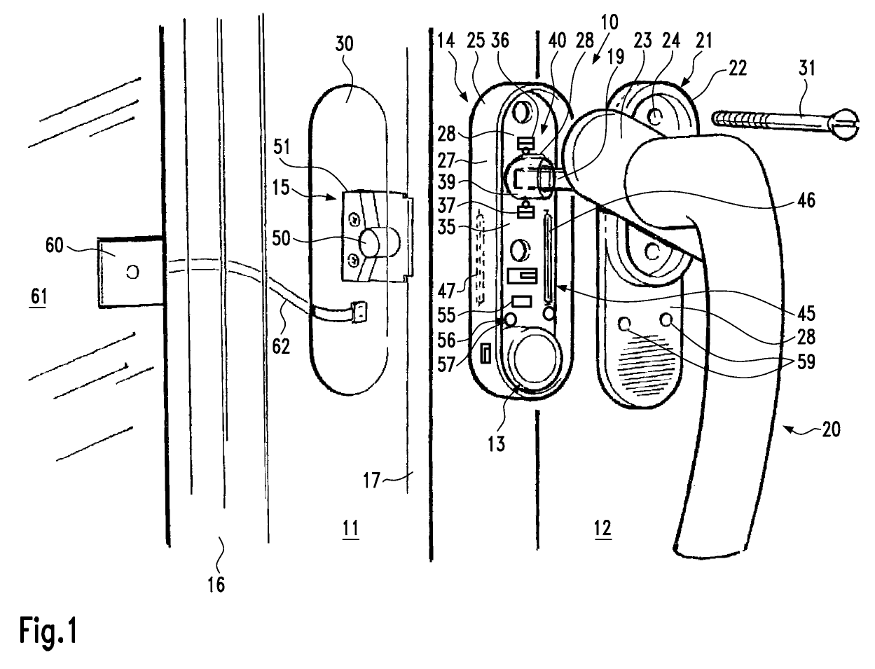

According to FIG. 1 the handle 20 is connected to a handle fitting 21 through which the multi-sided insert pin 19 extends and which arrests the handle 20 in the various, here three, rotation positions. Between the end of the handle 20 connected to the multi-sided insert pin 19 and a housing 22 of the handle fitting 23 a housing cover is swivellably provided which releases fixing holes 24.

The main part 14 of the monitoring device 10, which substantially contains a first sensor device 40 and parts of a second sensor device 45 as well as the alarm device 13 and a display device 56, is accommodated in a main housing 25 made of plastic, which overall is oblong, not very deep, and narrow. The main housing 25 has a base 26 and a peripheral wall 27 connected in one piece to it as well as a removable cover 28. The length of the main housing 25 is greater than that of the handle fitting housing 22. In the represented embodiment example the handle fitting housing 22 is in one piece with the cover 28 of the main housing 25 for the monitoring device 10. As shown by a dotted line, the handle fitting housing 22 can also be separate and provided with a base with which it can be fitted immovably onto the cover 28 of the main housing 25.

The main housing 25, which is rotatably penetrated by the multi-sided insert pin 19 in round recesses in the cover 28 and in the base 26, is inserted in its operating position into a corresponding recess 30 in the closure-side frame piece 16 of the wing frame 11 and secured to the closure-side frame piece 16 by means of screws 31 adjoining the handle 20. The recess 30 in the frame piece 16 is such that, when the cover edge 28 rests on the frame surface, it contains the whole main housing 25, while the handle fitting housing 22 projects.

Incorporated substantially unmovable on the base 26 of the main housing 25 is a circuit board 32 on which electric and electronic elements of the first and second sensor devices 40, 45 and further devices of the monitoring device 10 are held. Arranged on the circuit board 35 in the area of the holes penetrated by the multi-sided insert pin 19 in cover 23 and circuit board 35 are two microswitches 36 and 37, lying diametrically opposite each other on the latter, which are formed as keys on which there acts a plastic switching cam 38 on the periphery of a switching sleeve 39 which is pushed onto the multi-sided insert pin 19 and unrotatably connected to the latter. In other words, the switching sleeve 39, which is cylindrical on its outer periphery, has a multi-sided interior and the axial switching cam projects from the outer periphery of the switching sleeve 39. When the handle 20 is turned the switching cam 38 is in active connection either with microswitch 36 or with microswitch 37 or with neither of the two. In the represented embodiment example in the represented locked closed position of the window wing 11 or handle 20 the switching cam 38 is in active connection with the microswitch 36, whereas, when the handle is horizontal, with neither of the microswitches 36, 37, and, when the wing 11 or handle 20 is tilted by 180°, with microswitch 37. It is self-evident that the spatial attachment of microswitches 36, 37 and switching cam 38 to the switching sleeve 39 can also be different. The two microswitches 36 and 37 as well as the switching sleeve 39 provided with at least one switching cam 38 are part of the first sensor device 40 which serve to record or detect the swivel position of the handle 20 and thereby one of the, usually three, positions of a window wing 11, namely the locked closed position, the unlocked open position and the tilted position.

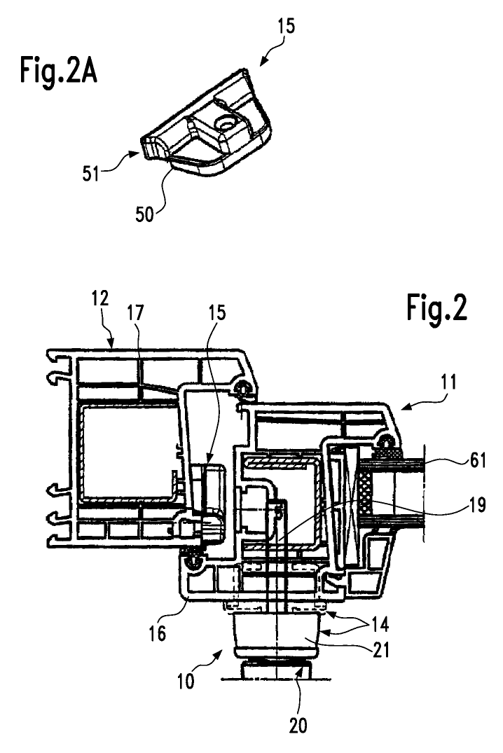

The second sensor device 45 of the monitoring device 10, which on the one hand is allocated to the main part 14 and on the other hand to the additional part 15, has two sealed-contact switches 46 and 47 which are attached on the circuit board 35 to an area facing away from the first sensor device 40. The two sealed-contact switches 46 and 47 are arranged along the opposite-facing long walls of the main housing 25. Allocated to one and/or other sealed-contact switch 46, 47 is a magnet 50, in each case being in active connection with this or these, which forms the additional part 15 of the monitoring device 10 and is arranged in the closure-side frame piece 17 of the fixed frame 12. In the represented embodiment example a plastic support 51 accommodating the magnet 50 is developed in a form which permits its installation by robots to the respective frame piece 17. This is achieved because the support 51 holding the magnet 50 has a form and dimensions which correspond to those fixed closure elements which cooperate with the fittings locking the movable wing. Here the support 51 with the magnet 50 corresponding to FIG. 2 is arranged in a fold 52 of the closure-side frame piece 17 of the fixed frame 12 at a spot which is arranged adjoining the recess 30 accommodating the main housing in the closure-side frame piece 16 of the wing frame 11.

Also held on the circuit board 35 is an evaluation unit 55 in the form of a microprocessor which processes the signals coming from the first sensor device 40 and from the second sensor device 45 and, as is still to be described, operates or starts the display device 56 and/or the alarm device 13. The display device 56 has two preferably differently coloured LEDs 57, 58, the light from which is visible from outside the cover 23 through inspection windows 59 or similar. The alarm device 13 has as alarm element a piezoelement which is held in the main housing cover 28 and connected to the circuit board 35 via a detachable plug-in device.

In a manner not represented in detail, a supply voltage source, such as for example a battery, can be connected to the circuit board 35 via a further plug-in device. This is provided for the case that the battery is accommodated outside the main housing 25 in the wing frame 25.

According to FIG. 1 the monitoring device 10 also has a glassbreak vibration detector 60 which is glued to a pane 61 of the wing 11 near the closure-side frame piece 16 and the connection cable of which passes through holes in the frame piece 16 and in the long wall of the main housing 25 and is connected to the circuit board 35 by a plug-in device.

The mode of operation of the monitoring device 10 is as follows:

Depending on the position of the handle 20, the microprocessor 55 detects, on the basis of the signals of the first sensor device 40, whether the window wing 11 is locked closed vis-à-vis the fixed frame 12 or whether there is no locking between wing 11 and fixed frame 12 or whether the wing 11 is tilted vis-à-vis the fixed frame 12. In the latter two cases for example the red LED 57 lights up as a warning. In the first named case, where the window wing is locked to the fixed frame 12, the microprocessor 25 operates a green LED 58. In the locked closed position of the wing 11 the adjoining magnet 50 in the fixed frame 12 effects a closing of the adjoining sealed-contact switch concerned 46 or 47, which the microprocessor 55 likewise records from the signal of the second sensor device 45. This can also be possible in the unlocked closed position of the wing 11 vis-à-vis the fixed frame 12. At the same time however the microprocessor 55 records via the first sensor device 40 that no locking has taken place, with the result that the monitoring device 10 does not operate the alarm device 13 when the wing 11 is intentionally or also unintentionally opened. Only when, in locked state the window wing 11 is forcibly levered open and the distance of the magnet 50 from the sealed-contact switch concerned 46 becomes larger, is the sealed-contact switch 46 or 47 opened which the microprocessor 55 records, with the result that the alarm device 13 is operated, here in the form of the acoustic signal.

Due to the two sealed-contact switches 46 and 47 being arranged parallel and on opposite long sides of the main housing 25, the main part 14 can be used for both left and right-hand stopped door or window wings 11; in addition is it possible in the case of oppositely stopped wings 11 to attach either just one magnet 50 or two spaced-apart magnets 50 to the common fixed frame piece, depending on its width.

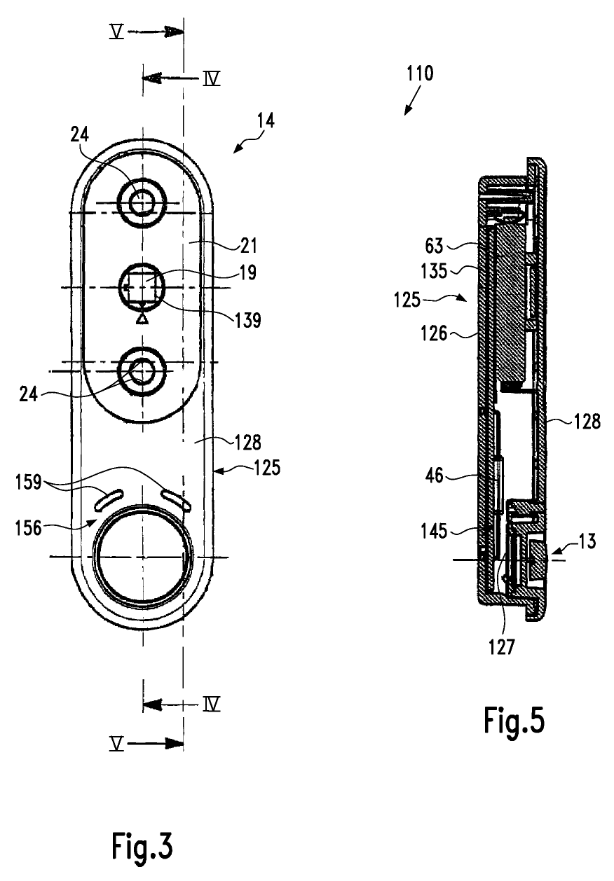

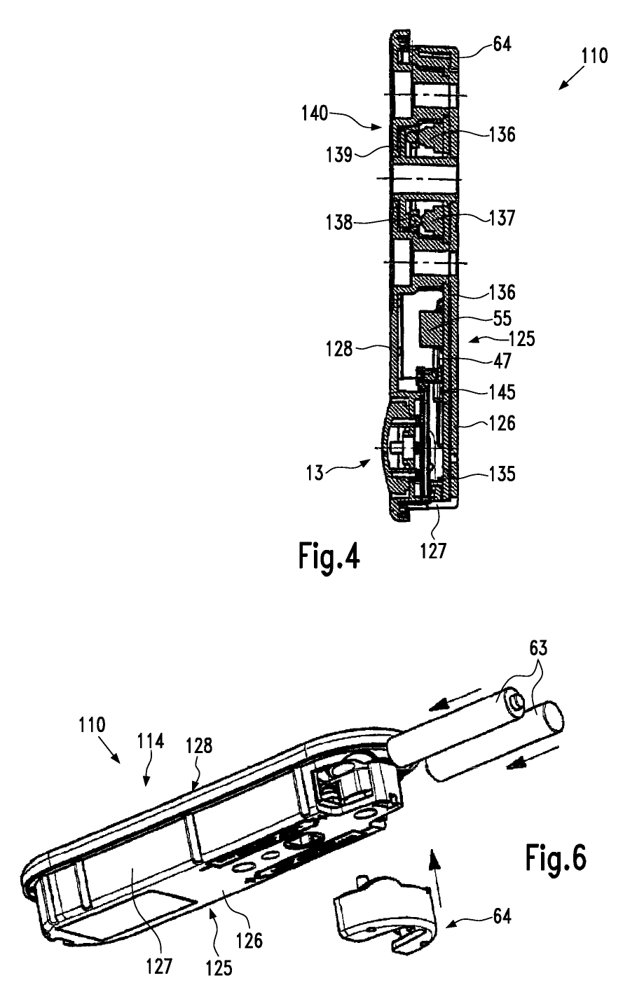

FIGS. 3 to 6 show a design variant of the monitoring device 110, which corresponds functionally to the monitoring device 10 of FIGS. 1 and 2, but differs in the design structure of the first sensor device 140 as well as in the configuration or attachment of the supply voltage source.

The first sensor device 140 according to FIGS. 3 to 6 differs from the corresponding first sensor device 40 according to FIGS. 1 and 2 in that the microswitches are held, not upright on the circuit board 135, but lying horizontal, and therefore the switching cam 138 attached to an indexing disk 139 presses, not radially but axially, on the microswitch 136, 137 concerned.

Furthermore the supply voltage source is integrated in the form of two batteries 63 into the main housing 25 such that the two batteries 63 are accommodated parallel to the long side walls and between the latter and the indexing disk 139 connected rotation-resistant to the multi-sided insert pin 19.

FIG. 6 shows the possibility of replacing the batteries 63 by fitting the main housing 125 in the area of the multi-sided insert pin 19 or of the indexing disk 138 with a removably catchable hood part 64 which frees the access to the two battery compartments attached to the longitudinal side walls.

The second sensor device 145 in this variant corresponds to the second sensor device 45 of FIGS. 1 and 2; this also applies to the evaluation unit 55 and to the alarm device 13 and the display device 156, which here is provided with two rounded inspection windows 159 as well as optical waveguides in the cover 128 above the LEDs.

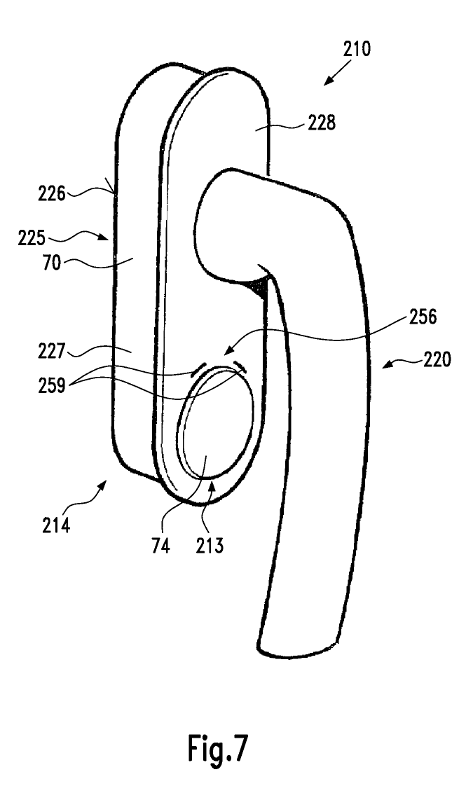

FIG. 7 shows a further embodiment of the main part 214 of the monitoring device 210 vis-à-vis the monitoring device 10, 110 according to FIGS. 1 and 2 or 3 to 6. Whereas, in the above-mentioned embodiment examples or variants, the main part 14, 114 of the monitoring device 10, 110 is provided in a separate main housing 25 with base 26 and cover 28, 128, onto which the handle fitting housing 22 is attached in two parts or one part with the main housing cover 28, in the embodiment example of FIG. 7 the main housing 25 and the handle fitting housing 22 are integrated or combined to form a single base housing 70 of the handle 220 as main housing 225. This base housing 70 has approximately the form of the main housing 25, 125 with a base 226 and a cover 228, which latter projects edge-side over the peripheral wall 227 and, at its end facing away from the fixing of the handle, is provided with the cover 74 of the alarm device 213 as well as with the rounded inspection windows, oblong here, for the display device 256. Also in this embodiment example the base housing 70 or the main housing 225 is sunk into a recess in the closure-side frame piece 16 of the window or door wing 11, wherein in sunken and installed state the edge-side projection of the cover 228 vis-à-vis the peripheral wall 227 sits on the inner surface, facing the living space, of the closure-side frame piece 16 of the wing 11.

1-21. (canceled)

22. A monitoring device for securing a window or a door, comprising:
a handle fitting;
a handle fitting housing;
a swivellable handle held on the handle fitting and connectable in a rotation-resistant manner via a multi-sided insert pin to a plurality of locking devices;
a housing at least partly accommodating the monitoring device;
a circuit board forming a base of the housing;
a housing cover swivellably disposed between an end of the handle and the handle fitting housing, wherein the housing cover includes a first hole and the housing base includes a second hole, the first and second holes penetrated by the multi-sided guide-pin;
a first sensor device configured to detect a swivel position of the handle, the first sensor device having first and second microswitches disposed on the circuit board in an area of the first and second holes, the first and second sensor devices being actuatable by a switching cam connected in a rotation resistant manner to the handle;
a second sensor device configured to detect a closed position, the second sensor device including at least two sealed-contact switches each disposed spaced apart along opposite facing long walls of the housing and a magnet cooperating with at least one of the sealed-contact switches, the magnet being attached to a closure-side arm of a fixed frame of the door or window; and
an evaluation unit configured to combine and evaluate the detection signals from the first and the second sensor devices.

23. The monitoring device as recited in claim 22, wherein the evaluation unit is configured to prompt an alarm signal based on the evaluation of the detection signals.

24. The monitoring device as recited in claim 22, wherein the switching cam includes a switching element disposed between the multi-sided insert pin and the microswitches.

25. The monitoring device as recited in claim 24, wherein the switching housed rotatably in the housing.

26. The monitoring device as recited in claim 22, wherein the single switching cam is provided in on of an axial and a radial extension of the switching element.

27. The monitoring device as recited in claim 22, wherein the first and second microswitches are disposed diagonally opposite each other.

28. The monitoring device as recited in claim 22, wherein the magnet is disposed in a fold of the closure-side fixed frame piece.

29. The monitoring device as recited in claim 28, wherein the magnet is set into the frame piece.

30. The monitoring device as recited in claim 28, further comprising a support in the form of a closure piece provided in the fixed frame, and wherein the magnet is held relative to the support.

31. The monitoring device as recited in claim 22, wherein the evaluation unit includes a microprocessor.

32. The monitoring device as recited in claim 22, further comprising an alarm device configured to generate at least one of a visual and an acoustic alarm and disposed in the housing and operable by the evaluation unit.

33. The monitoring device as recited in claim 32, wherein the alarm device is disposed in or against a housing cover.

34. The monitoring device as recited in claim 22, wherein the handle fitting is integrated into the housing.

35. The monitoring device as recited in claim 22, wherein the housing is disposed sunk in the closure-side frame piece of the window or door wing.

36. The monitoring device as recited in claim 35, wherein the housing cover is disposed edge-side on a room-side surface of the closure-side frame piece of the wing.

37. The monitoring device as recited in claim 22, further comprising a display device disposed in the housing and configured to indicate a locked closed position.

38. The monitoring device as recited in claim 22, further comprising a plug-in connector terminal disposed in the housing configured for connection to an external glassbreak vibration detector.

39. The monitoring device as recited in claim 22, further comprising a voltage supply terminal for a disposed in the housing.

40. The monitoring device as recited in claim 39, further comprising a battery replacably disposed in the housing and connected to the voltage supply terminal, and a catchable hood disposed on a base-side of the housing in an area of the first sensor device.

41. The monitoring device as recited in claim 22, wherein the circuit board carries the microswitches, sealed-contact switches and evaluation unit.

42. A window or door having a monitoring device according to claim 41.

43. The window or door according to claim 42, further comprising an oppositely slopped wing and a common closure-side fixed frame piece provided with a common magnet for the second sensor devices.
